(19) United States
(12) Patent Application Publication
(10) Pub. No.: US 2005/0058760 A1
(43) Pub. Date: Mar. 17, 2005

(54) Method for making instant maftul

(76) Inventor: Avi Chriqui, Kfar Sava (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/969,030

(22) Filed: Oct. 21, 2004

Related U.S. Application Data
(63) Continuation-in-part of application No. 10/078,497, filed on Feb. 21, 2002, now abandoned.

(30) Foreign Application Priority Data
Apr. 5, 2001 (IL) 142477

(51) Int. Cl. A23L 1/00

(52) U.S. Cl. 426/557

(57) ABSTRACT

A method for making an instant maftul including sifting flour, mixing water with the flour to form non-extruded maftul granules, steam-cooking the maftul granules under pressure, and drying the maftul.

### CROSS-REFERENCE TO PREVIOUS APPLICATIONS

This application is a continuation-in-part application of and claims priority from U.S. patent application Ser. No. 10/078,497, filed Feb. 21, 2002.

### FIELD OF THE INVENTION

The present invention relates generally to mini-pasta, e.g., maftul, and methods for instant preparation thereof.

### BACKGROUND OF THE INVENTION

Maftul is a Palestinian dish, a type of mini-pasta, especially popular amongst Arabs in Israel, Jordan, Lebanon and Syria. Maftul (or meftul, depending on the Arabic dialect) is made only from flour and water, with no preservatives or additives whatsoever. Maftul consists of small round particles, similar in shape to another Middle Eastern dish, couscous, which originates from North Africa. However, couscous differs from maftul, in that couscous is made from semolina, not flour.

Traditionally, couscous and maftul are made from scratch from raw materials, a process that takes several hours. The present applicant has developed an instant mix for preparation of couscous, which has enjoyed much commercial success and which has widened the popularity of couscous.

However, maftul is made from flour, unlike couscous which is made from semolina. An article from the worldwide website barilla.com/ricette, outlines some of the differences between semolina and flour. The article states, “The average size of a particle of durum wheat semolina is approximately 250-300 microns, while the size of a particle of common wheat flour is about 100 microns. Semolina particles have sharp edges obtained through a special grinding process. Common wheat flour is nearly always white, while semolina has an amber yellow color. Pasta can also be made from flour, but it's white, doesn't maintain its consistency after cooking and tends to stick: Consumers judge these attributes as indicators of poor quality.”

U.S. Pat. No. 5,427,809 to Donnely et al., in the background, gives a recipe for making instant couscous: “As in the traditional method, the first step of the known commercial method is that of blending water and semolina until optimum agglomeration or granule formation is achieved . . . A mechanical mixer such as a paddle mixer is used for this step and the mixing takes about 3 minutes to provide granules of a moisture content of about 30-35% . . . The next step of the known commercial method involves feeding the coarse, irregularly shaped and random-sized moist granules into a detacher where the granules of oversize are reduced and those of proper size are strengthened and shaped to form the couscous agglomerates . . . Thereafter wet sifting may be done to separate undesired fines and oversized particles from the proper size range for the agglomerates . . . Next the couscous agglomerates are passed on a conveyor belt through a steam cooking operation. This steaming step takes about 8 minutes at a temperature of about 180° C. The moisture of the couscous product is elevated to about 37% by weight by the time the product exits the steaming operation . . . The agglomerates are then dried in climate-controlled dryers . . . Drying is conducted until the product moisture is reduced below 13%, preferably to 10-12% . . .”

However, attempts to use the abovementioned couscous recipe from Donnely et al. to make instant maftul, produces sticky, pasty maftul with very little airiness and no traditional mouthfeel.

### SUMMARY OF THE INVENTION

The present invention seeks to provide instant mini-pasta, e.g., maftul, and methods for preparation of instant mini-pasta.

There is thus provided in accordance with a preferred embodiment of the present invention a method for making instant maftul, including sifting flour with approximately a No. 40 sieve as defined in accordance with the ASTM (American Standard of Testing Materials) E-II specification for testing fine and coarse sieves, mixing water with the flour to form generally spherical, non-extruded maftul granules, steam-cooking the maftul granules under pressure to form instant maftul, and drying the instant maftul. The drying may include pre-drying the maftul to remove vapors from the maftul, and then fully drying the maftul.

### DETAILED DESCRIPTION OF EMBODIMENTS

The invention is described herein for making maftul. However, this is just one example of mini-pasta made from flour, and it is appreciated that the invention is applicable to other kinds of mini-pasta made from flour and is not limited to maftul.

Maftul is made from flour, preferably wheat flour, delivered from a flour manufacturer in sacks and the like. The flour is preferably inspected, for example, visually inspected for quality and moisture content. The flour is then typically stored in a storage area or container.

In accordance with one embodiment of the present invention, the flour is sifted, preferably using approximately a No. 40 sieve. (It is noted, however, that this is just an exemplary value, and the invention is not limited to this value.) The term “No. 40 sieve” refers to the United States Standard ASTM (American Standard of Testing Materials) E-II specification for testing fine and coarse sieves. In this standard, a No. 40 sieve has a nominal sieve opening of 419 μm (±19 μm) and a nominal wire diameter of 0.29 mm. This is in contrast to the preparation of instant couscous, wherein a No. 20 sieve is used to sift the semolina. In the ASTM E-II standard, a No. 20 sieve has a nominal sieve opening of 841 μm (±35 μm) and a nominal wire diameter of 0.51 mm. Moreover, in a preferred embodiment, the flour used to make instant maftul is sifted in a single-mesh centrifugal No. 40 sieve. In contrast, in the preparation of instant couscous, the semolina is sifted in a double-mesh rotating No. 20 sieve.

After sifting, the flour may be mixed thoroughly with water to form maftul granules. Unlike some prior art pasta, the maftul granules are not extruded but rather are formed into generally, round, spherical granules during the mixing process. In a preferred embodiment, the flour and water are mixed in a mixer with a water flow rate of about 250 liters per hour. It is again stressed, however, that this is just an exemplary value, and the invention is not limited to this value.

The maftul granules (flour-water mixture) may be then steam-cooked under pressure to form maftul, such as on a cooking conveyor that passes through pressurized steam. For example, the working pressure may be about 3.7 bars and the steam flow rate may be about 500 kg/hour. (Again the invention is not limited to these values.) The maftul is preferably visually (or otherwise) inspected during cooking.

The cooked maftul may be then dried, preferably by means of pre-drying and final drying. The main purpose of the pre-drying is to remove vapors from the maftul . . . Pre-drying may consist of drying in an oven at about 100° C. for 6 minutes. (Again the invention is not limited to these values.) The pre-dried maftul may be then fully (final) dried, such as in an oven at about 110° C. for 25 minutes. (Again the invention is not limited to these values.)

The finished maftul is similar to traditional maftul: it is not sticky, not pasty, and has traditional airiness and mouthfeel.

The finished maftul preferably undergoes various inspections, such as, but not limited to, moisture content, consistency, quality and the like. After passing inspection, the maftul may be packed, which may comprise sorting the maftul into different sizes and packing the different sizes. The packaged maftul is then stored until sale or use.

The finished maftul may be prepared by reconstituting the dried maftul mix in boiling water for about 10 minutes.

It will be appreciated by person skilled in the art, that the present invention is not limited by what has been particularly shown and described herein above. Rather the scope of the present invention is defined only by the claims that follow:

1. A method for making instant maftul, comprising:
sifting flour with approximately a No. 40 sieve as defined in accordance with the ASTM (American Standard of Testing Materials) E-II specification for testing fine and coarse sieves;
mixing water with said flour to form generally spherical, non-extruded maftul granules, steam-cooking said maftul granules under pressure to form instant maftul, and drying said instant maftul.

2. The method according to claim 1, wherein said drying comprises pre-drying said maftul to remove vapors from said maftul, and fully drying said maftul.

3. The method according to claim 1, wherein said sifting comprises sifting with a single-mesh centrifugal sieve.

4. The method according to claim 1, wherein said maftul granules are steam-cooked on a cooking conveyor that passes through pressurized steam.

5. The method according to claim 1, wherein said mixing comprises mixing said flour and water in a mixer with a water flow rate of generally 250 liters per hour.

6. The method according to claim 1, wherein said steam-cooking comprises steam-cooking said maftul granules with a working pressure of generally 3.7 bars and a steam flow rate of generally 500 kg/hour.

7. The method according to claim 2, wherein said pre-drying comprises pre-drying in an oven generally at 100° C. for 6 minutes.

8. The method according to claim 2, wherein said fully drying comprises fully drying said maftul in an oven generally at 110° C. for 25 minutes.

9. The method according to claim 1, further comprising sorting said maftul into different sizes after fully drying.

10. An instant maftul made by:
sifting flour with approximately a No. 40 sieve as defined in accordance with the ASTM (American Standard of Testing Materials) E-II specification for testing fine and coarse sieves, mixing water with said flour to form generally spherical maftul granules, steam-cooking said maftul granules under pressure to form instant maftul, and drying said instant maftul.
